(19) United States
(12) Patent Application Publication
(10) Pub. No.: US 2020/0184277 A1
(43) Pub. Date: Jun. 11, 2020

(54) RECORDING MEDIUM THAT STORES REINFORCEMENT LEARNING PROGRAM, REINFORCEMENT LEARNING METHOD, AND REINFORCEMENT LEARNING APPARATUS

(71) Applicant: FUJITSU LIMITED, Kawasaki-shi (JP)

(72) Inventors: Hidenao Iwane, Kawasaki (JP); Tomotake Sasaki, Kawasaki (JP); Hitoshi Yanami, Kawasaki (JP)

(73) Assignee: FUJITSU LIMITED, Kawasaki-shi (JP)

(21) Appl. No.: 16/702,676

(22) Filed: Dec. 4, 2019

(30) Foreign Application Priority Data
Dec. 6, 2018 (JP) 2018-229484

(51) Int. Cl. G06K 9/62; G05B 13/02

(52) U.S. Cl. CPC G06K 9/6264; G05B 13/0265

(57) ABSTRACT

A reinforcement learning method is performed by a computer. The method includes: acquiring an input value related to a state and an action of a control target and a gain of the control target that corresponds to the input value; estimating coefficients of state-action value function that becomes a polynomial for a variable that represents the action of the control target, or becomes a polynomial for a variable that represents the action of the control target when a value is substituted for a variable that represents the state of the control target, based on the acquired input value and the gain; and obtaining an optimum action or an optimum value of the state-action value function with the estimated coefficients by using a quantifier elimination.

### CROSS-REFERENCE TO RELATED APPLICATION

This application is based upon and claims the benefit of priority of the prior Japanese Patent Application No. 2018-229484, filed on Dec. 6, 2018, the entire contents of which are incorporated herein by reference.

### FIELD

The embodiment discussed herein is related to a non-transitory computer-readable recording medium that stores a reinforcement learning program, a reinforcement learning method, and a reinforcement learning apparatus.

### BACKGROUND

In the related art, there is a technology of reinforcement learning for improving a value function that indicates a cumulative gain of a control target based on a gain obtained from a control target that corresponds to an action for the control target, and for determining the next action such that the cumulative gain is optimized based on the improved value function. The gain is, for example, a reward. The value function is, for example, a state-action value function (Q function). In the reinforcement learning, there is a case where the action is treated as a discrete quantity. Japanese Laid-open Patent Publication Nos. 2013-47869, 2014-59804, 2014-211667, and 2015-125198 are examples of related art.

When the action is treated as a discrete quantity in the reinforcement learning, there is a case where it becomes difficult to finely adjust the action and efficiently control the control target, and there is a case where it is required to treat the action as a continuous quantity in the reinforcement learning based on the value function. However, in the related art, it is difficult to treat the action as a continuous quantity in the reinforcement learning. For example, when the state-action value function is improved or the next action is determined, the optimization problem based on the state-action value function is solved, but when the action is treated as a continuous quantity, it is difficult to solve the optimization problem.

According to an aspect, an object of the present embodiment is to provide a reinforcement learning program, a reinforcement learning method, and a reinforcement learning apparatus that make it possible to treat an action as a continuous quantity in reinforcement learning.

### SUMMARY

According to an aspect of the embodiments, a reinforcement learning method is performed by a computer. The method includes: acquiring an input value related to a state and an action of a control target and a gain of the control target that corresponds to the input value; estimating coefficients of state-action value function that becomes a polynomial for a variable that represents the action of the control target, or becomes a polynomial for a variable that represents the action of the control target when a value is substituted for a variable that represents the state of the control target, based on the acquired input value and the gain; and obtaining an optimum action or an optimum value of the state-action value function with the estimated coefficients by using a quantifier elimination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a reinforcement learning method according to an embodiment;

FIG. 2 is a block diagram illustrating a hardware configuration example of a reinforcement learning apparatus;

FIG. 3 is an explanatory diagram illustrating an example of stored contents of a coefficient array;

FIG. 4 is an explanatory diagram illustrating an example of stored contents of a history table;

FIG. 5 is a block diagram illustrating a functional configuration example of the reinforcement learning apparatus;

FIG. 6 is an explanatory diagram (part 1) illustrating a flow of reinforcement learning in an example;

FIG. 7 is an explanatory diagram (part 2) illustrating a flow of the reinforcement learning in the example;

FIG. 8 is an explanatory diagram (part 1) illustrating a specific example of a control target;

FIG. 9 is an explanatory diagram (part 2) illustrating a specific example of the control target;

FIG. 10 is an explanatory diagram (part 3) illustrating a specific example of the control target; and

FIG. 11 is a flowchart illustrating an example of a reinforcement learning processing procedure.

### DESCRIPTION OF EMBODIMENTS

Hereinafter, with reference to the drawings, an embodiment of a reinforcement learning program, a reinforcement learning method, and a reinforcement learning apparatus according to the present embodiment will be described in detail.

(One Example of Reinforcement Learning Method According to Embodiment)

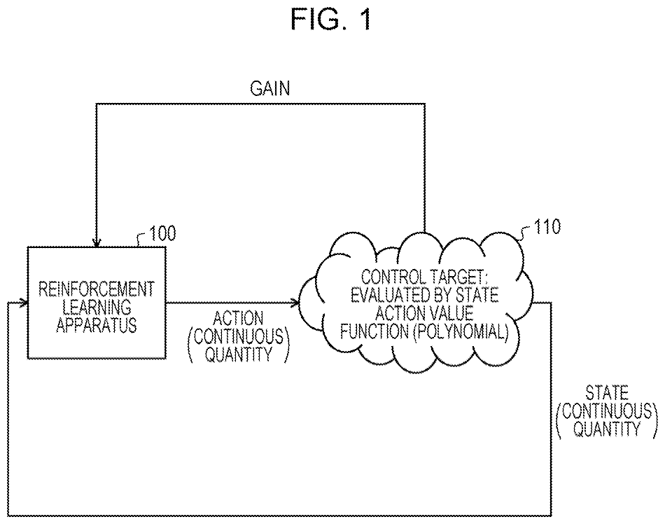

FIG. 1 is an explanatory diagram illustrating an example of the reinforcement learning method according to the embodiment. A reinforcement learning apparatus 100 is a computer that controls a control target 110 by determining an action for the control target 110 by reinforcement learning. The reinforcement learning apparatus 100 is, for example, a server, a personal computer (PC), or the like.

The control target 110 is some object or phenomenon, for example, a physical system that actually exists. Specifically, the control target 110 is an automobile, an autonomous mobile robot, a computer room air conditioning (CRAC) unit, a generator, or the like. The action is an operation with respect to the control target 110. The action is also called input. The state of the control target 110 changes in accordance with the action with respect to the control target 110, and it is possible to observe the state of the control target 110.

The reinforcement learning is a technology for improving a value function that indicates a cumulative gain of the control target 110, and for determining the next action such that the cumulative gain is optimized based on the improved value function. The gain is, for example, a reward. The gain is, for example, a value obtained by multiplying the cost by a negative value, and may be a value that makes it possible to be treated as a reward. The optimization corresponds to, for example, maximization. In the reinforcement learning, there is a case where the action is treated as a discrete quantity. Regarding technologies for treating the action as a discrete quantity, it is possible to refer to the following reference literatures 1 to 4, for example.

Reference Literature 1: Watkins, Christopher John Cornish Hellaby, “Leaming from delayed rewards.” Diss. University of Cambridge, 1989.

Reference Literature 2: Lin, C-S., and Hyongsuk Kim. “CMAC-based adaptive critic self-learning control” IEEE Transactions on Neural Networks Vol. 2. No. 5 (1991): 530-533.

Reference Literature 3: Tham, Chen K. “Reinforcement learning of multiple tasks using a hierarchical CMAC architecture.” Robotics and Autonomous Systems 15. 4 (1995): 247-274.

Reference Literature 4: Sutton, Richard S. “Generalization in reinforcement learning: Successful examples using sparse coarse coding.” Advances in neural information processing systems (1996): 1038-1044.

However, when the action is treated as a discrete quantity in the reinforcement learning, there is a case where it becomes difficult to finely adjust the action and efficiently control the control target 110. When the action is discretized, there is a case where it becomes difficult to determine the size of unit of discretization, and it becomes difficult to efficiently control the control target 110.

For example, in a case where the autonomous mobile robot is the control target 110 and the designated value in the moving direction for the autonomous mobile robot is the action for the autonomous mobile robot, the designated value in the moving direction for the autonomous mobile robot is discretized, and there is a case where the designated value in the moving direction is limited to four directions including forward, rearward, leftward, and rightward directions. In this case, even when the autonomous mobile robot has a mechanism that makes it possible to move in any direction of 360 degrees in the horizontal direction, the autonomous mobile robot moves only in any one of the four directions including forward, rearward, leftward, and rightward directions, and thus, it becomes impossible to efficiently move, and it becomes difficult to avoid danger.

It is sometimes considered that it is possible to finely adjust the action by reducing the unit of discretization and finely discretizing the action. However, when the action is finely discretized, in the reinforcement learning, an increase in the time required for improving the value function, the time required for determining the next action, and the like is caused. Meanwhile, in a case where the unit of discretization is too large, there is a case where it is not possible to obtain sufficient performance in the control of the control target 110.

For example, in the reinforcement learning, such as Q-learning and State-Action-Reward-State(next)-Action(next) or SARSA, when determining an action, an optimization problem for obtaining an action that optimizes the value function is solved. For example, in the reinforcement learning, such as Q-learning, when improving the value function, an optimization problem for obtaining an optimum value of the value function is solved. In a case where the actions are finely discretized, the value of the value function is comprehensively calculated using each of the discretized actions, the optimum value of the value function is obtained, and as the number of discretized actions increases, it takes more time for improving the value function.

In this manner, when the action is treated as a discrete quantity in the reinforcement learning, there is a case where it becomes difficult to finely adjust the action and efficiently control the control target 110, and thus, it is required to treat the action as a continuous quantity in the reinforcement learning. However, it is difficult to treat the action as a continuous quantity in the reinforcement learning.

For example, when the value function is improved or the next action is determined, the optimization problem based on the value function is solved, but when the action is treated as a continuous quantity, it is difficult to solve the optimization problem. Specifically, it is difficult to solve the optimization problem because it is difficult to comprehensively calculate the value of the value function using all the continuous actions and obtain the optimum value of the value function.

In the reinforcement learning, there is a case where it is desirable to be able to use a constraint condition when improving the value function and determining the next action in order to accurately consider the properties of the control target 110. The constraint condition is a condition that defines a possible range of adaptation as an action, for example.

In the embodiment, a reinforcement learning method in which the value function is expressed by a polynomial using a variable that represents the action, and by using a quantifier elimination on the real closed field, it is possible to treat the action as a continuous quantity, and it is possible to use the constraint condition, will be described. In the following description, the quantifier elimination on a real closed field is simply expressed as quantifier elimination.

The quantifier elimination is also called QE. In the following description, there is a case where the quantifier elimination is expressed as “QE”. The quantifier elimination is to convert a logical expression described by using a quantifier into an equivalent logical expression that does not use a quantifier. The quantifier is a universal quantifier (∀) and an existential quantifier (∃). The universal quantifier (∀) is a symbol that expresses that all real numbers are targets. The existential quantifier (∃) is a symbol that expresses that at least one target real number exists.

In FIG. 1, the reinforcement learning apparatus 100 acquires an input value related to the state and the action and a gain that corresponds to the input value. For example, the reinforcement learning apparatus 100 observes the state of the control target 110 at predetermined time intervals, and acquires and stores the observed state as an input value of the state. The reinforcement learning apparatus 100 acquires and stores the action for the control target 110 at predetermined time intervals as an input value of the action. The reinforcement learning apparatus 100 acquires the gain in the control target 110 after a predetermined period of time from the action for each action for the control target 110. Specific examples of acquiring the input value and the gain will be described later in the example.

The reinforcement learning apparatus 100 estimates coefficients of the state-action value function based on the acquired input value and gain. The state-action value function is, for example, a function that becomes a polynomial for a variable that represents the action, or a polynomial for a variable that represents the action when a value is substituted into a variable that represents the state. The coefficients are applied to a polynomial and are multiplied by a variable that represents an action or a variable that represents a state. The coefficients are learned by the reinforcement learning. For example, the reinforcement learning apparatus 100 uses an input value related to the state and action acquired up to a predetermined timing, and a gain that corresponds to the input value, as the acquired input value and gain. A specific example of estimating the coefficients of the state-action value function will be described later in the example.

The reinforcement learning apparatus 100 obtains an optimum action or an optimum value of the state-action value function with the estimated coefficients by using the QE. For example, the reinforcement learning apparatus 100 uses the QE to transform a logical expression including the state-action value function into a logical expression that does not include the variable that represents the action, and obtains the optimum action or the optimum value of the state-action value function. Specific examples for obtaining the optimum action or the optimum value will be described later in the example.

Accordingly, in the reinforcement learning apparatus 100, in the reinforcement learning, it is possible to treat the action as a continuous quantity, and it is possible to finely adjust the action, and to efficiently control the control target 110. In the reinforcement learning apparatus 100, it is possible to obtain the optimum value of the state-action value function without comprehensively calculating the value of the state-action value function using all of the continuous actions, it is possible to suppress an increase in time required for the reinforcement learning. For example, in the reinforcement learning apparatus 100, it is possible to suppress an increase in time required when improving the state-action value function and determining the next action.

The logical expression including the state-action value function may further include a constraint condition. Accordingly, in the reinforcement learning apparatus 100, it is possible to use the constraint condition in the reinforcement learning, and to control the control target 110 by accurately considering the properties of the control target 110. Therefore, in the reinforcement learning apparatus 100, it is possible to apply the reinforcement learning to various types of control targets 110, and to improve the convenience of the reinforcement learning. Specific examples of making it possible to use the constraint condition will be described later in the example.

(Hardware Configuration Example of Reinforcement Learning Apparatus 100)

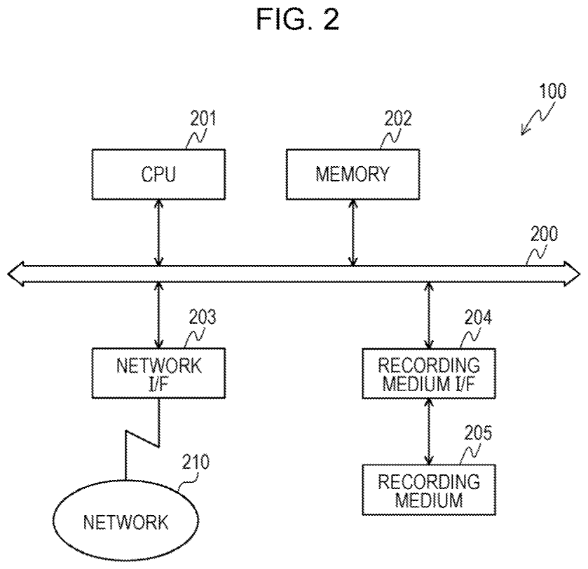

Next, a hardware configuration example of the reinforcement learning apparatus 100 will be described with reference to FIG. 2.

FIG. 2 is a block diagram illustrating the hardware configuration example of the reinforcement learning apparatus 100. In FIG. 2, the reinforcement learning apparatus 100 includes a central processing unit (CPU) 201, a memory 202, a network interface (I/F) 203, a recording medium I/F 204, and a recording medium 205. Each of the configuration portions is coupled to each other via a bus 200.

The CPU 201 controls the entirety of the reinforcement learning apparatus 100. The memory 202 includes, for example, a read-only memory (ROM), a random-access memory (RAM), a flash ROM, and the like. For example, the flash ROM or the ROM stores various programs, and the RAM is used as a work area of the CPU 201. The program stored in the memory 202 causes the CPU 201 to execute coded processing by being loaded into the CPU 201.

The network I/F 203 is coupled to the network 210 through a communication line and is coupled to another computer via the network 210. The network I/F 203 controls the network 210 and an internal interface so as to control data input/output from/to the other computer. As the network I/F 203, for example, it is possible to adopt a modem, a LAN adapter, or the like.

The recording medium I/F 204 controls reading/writing of data from/to the recording medium 205 under the control of the CPU 201. The recording medium I/F 204 is, for example, a disk drive, a solid state drive (SSD), a Universal Serial Bus (USB) port, or the like. The recording medium 205 is a nonvolatile memory that stores the data written under the control of the recording medium I/F 204. The recording medium 205 is, for example, a disk, a semiconductor memory, a USB memory, or the like. The recording medium 205 may be detachable from the reinforcement learning apparatus 100.

In addition to the above-described components, the reinforcement learning apparatus 100 may include, for example, a keyboard, a mouse, a display, a speaker, a microphone, a printer, a scanner, and the like. The reinforcement learning apparatus 100 may not include the recording medium I/F 204 or the recording medium 205.

(Stored Contents of Coefficient Array W)

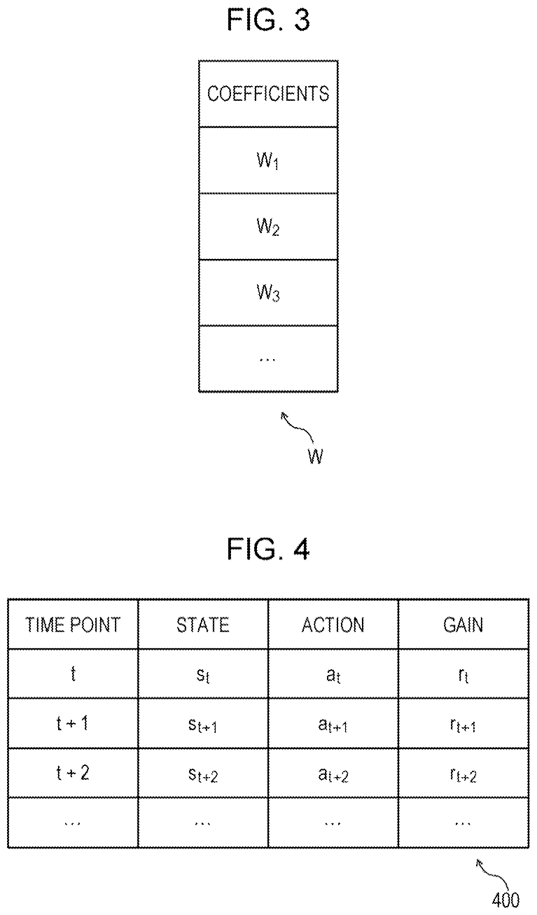

Next, the stored contents in the coefficient array W will be described with reference to FIG. 3. The coefficient array W is realized by, for example, a storage region, such as the memory 202 or the recording medium 205 of the reinforcement learning apparatus 100 illustrated in FIG. 2.

FIG. 3 is an explanatory diagram illustrating an example of the stored contents of the coefficient array W. As illustrated in FIG. 3, the coefficient array W has a coefficient field. The coefficient array W stores coefficient information by setting information in each field for each coefficient.

In the coefficient field, coefficients that defines the state-action value function are set.

(Stored Contents of History Table 400)

Next, the stored contents of a history table 400 will be described with reference to FIG. 4. The history table 400 is realized by, for example, a storage region, such as the memory 202 or the recording medium 205 of the reinforcement learning apparatus 100 illustrated in FIG. 2.

FIG. 4 is an explanatory diagram illustrating an example of the stored contents of the history table 400. As illustrated in FIG. 4, the history table 400 includes fields of the state, the action, and the gain in association with a time point field. The history table 400 stores specific quantity information by setting information in each field for each time.

In the time point field, time points at predetermined time intervals are set. In the state field, the states of the control target 110 at the time points are set. In the action field, the actions for the control target 110 at the time points are set. In the gain field, the gains that correspond to the actions for the control target 110 at the time points are set.

(Functional Configuration Example of Reinforcement Learning Apparatus 100)

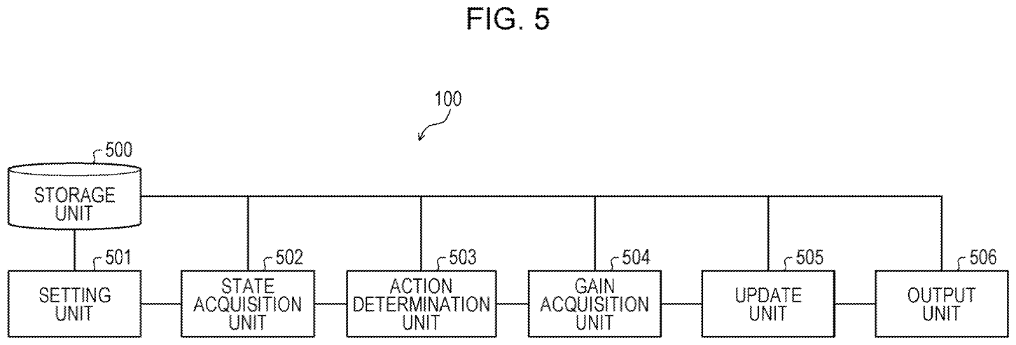

Next, a functional configuration example of the reinforcement learning apparatus 100 will be described with reference to FIG. 5.

FIG. 5 is a block diagram illustrating the functional configuration example of the reinforcement learning apparatus 100. The reinforcement learning apparatus 100 includes a storage unit 500, a setting unit 501, a state acquisition unit 502, an action determination unit 503, a gain acquisition unit 504, an update unit 505, and an output unit 506.

The storage unit 500 is realized by using, for example, a storage region, such as the memory 202 or the recording medium 205 illustrated in FIG. 2. Units from the setting unit 501 to the output unit 506 provide functions of a control unit. Specifically, the functions of the units from the setting unit 501 to the output unit 506 are realized by, for example, causing the CPU 201 to execute a program stored in the storage region, such as the memory 202 or the recording medium 205 illustrated in FIG. 2, or by using the network I/F 203. Results of processing performed by each functional unit are stored, for example, in the storage region, such as the memory 202 or the recording medium 205 illustrated in FIG. 2.

The storage unit 500 stores the action, the state, and the gain of the control target 110. The storage unit 500 stores, for example, the action, the state, and the gain of the control target 110 using the history table 400. Accordingly, the storage unit 500 is capable of making each processing unit refer to the action, the state, and the gain of the control target 110.

The storage unit 500 stores the state-action value function. The state-action value function becomes, for example, a polynomial for a variable that represents the action, or a polynomial for a variable that represents the action when a value is substituted into a variable that represents the state. The polynomial for the variable that represents the action may be non-linear. The polynomial for the variable that represents the action may include, for example, the square of the variable that represents the action. The storage unit 500 stores, for example, the coefficients of the state-action value function. The coefficients are applied to a polynomial and is multiplied by a variable that represents an action or a variable that represents a state. The coefficients are learned by the reinforcement learning. Specifically, the coefficient is wᵢ which will be described later. Accordingly, the storage unit 500 is capable of making each processing unit refer to the state-action value function.

The setting unit 501 initializes variables used by each processing unit. For example, the setting unit 501 initializes the coefficients of the state-action value function based on an operation input of the user. For example, the setting unit 501 sets a constraint condition based on the operation input of the user. An operation example of the setting unit 501 will be described later in the example, for example. Accordingly, the setting unit 501 is capable of making it possible to use the state-action value function at a time point when the update unit 505 has not yet estimated the coefficients of the state-action value function. The setting unit 501 is capable of causing each processing unit to refer to the constraint condition.

The state acquisition unit 502 acquires an input value related to the state. For example, the reinforcement learning apparatus 100 observes a value that indicates the state of the control target 110 at predetermined time intervals, acquires the value as an input value related to the state, and stores the acquired input value in the storage unit 500 in association with the observed time point. An operation example of the state acquisition unit 502 will be described later in the example, for example. Accordingly, the state acquisition unit 502 is capable of causing the action determination unit 503 or the update unit 505 to refer to the input value related to the state.

The action determination unit 503 obtains the optimum action or the optimum value of the state-action value function by using the quantifier elimination, and determines the current action for the control target 110. The optimum value is, for example, the maximum value. The optimum action is an action that makes the state-action value function an optimum value.

The action determination unit 503 obtains the optimum action or the optimum value of the state-action value function by using the coefficients initialized by the setting unit 501 or the coefficients estimated by the update unit 505, for example, by using the quantifier elimination. Specifically, the action determination unit 503 estimates the coefficients of the state-action value function based on the input value related to the state, the input value related to the action, and the gain that corresponds to the input value, which are acquired up to a predetermined timing.

More specifically, the action determination unit 503 specifies a possible range of the state-action value function by using the quantifier elimination for the logical expression including the state-action value function based on the acquired input value related to the state and the input value related to the action. Next, the action determination unit 503 obtains an optimum value of the state-action value function by using the quantifier elimination for the logical expression including the specified range. The action determination unit 503 obtains the optimum action of the state-action value function by using the quantifier elimination for the logical expression including the obtained optimum value. After this, the action determination unit 503 determines the obtained optimum action or the action obtained by adding noise to the obtained optimum action as the current action for the control target 110. Accordingly, the action determination unit 503 is capable of determining a preferable action for the control target 110, and efficiently controlling the control target 110.

The action determination unit 503 may obtain the optimum action or the optimum value of the state-action value function by using the coefficients estimated by the update unit 505, to which the constraint condition is applied, by using the quantifier elimination. Accordingly, the action determination unit 503 is capable of determining a preferable action for the control target 110, which satisfies the constraint condition and efficiently controlling the control target 110.

The action determination unit 503 stores the input value related to the action in the storage unit 500. For example, the action determination unit 503 stores a value that indicates the determined current action in the storage unit 500 as an input value related to the action. An operation example of the action determination unit 503 will be described later in the example, for example. Accordingly, the action determination unit 503 is capable of referring to the current action for the control target 110 when determining the next action for the control target 110.

The gain acquisition unit 504 acquires the gain that corresponds to the input value related to the action. The gain acquisition unit 504 acquires the gain in the control target 110 after a predetermined period of time after the action is performed every time the action for the control target 110 is performed. An operation example of the gain acquisition unit 504 will be described later in the example, for example. Accordingly, the gain acquisition unit 504 is capable of making the update unit 505 refer to the gain.

The update unit 505 estimates the coefficients of the state-action value function based on the acquired input value related to the state, the input value related to the action, and the gain. The update unit 505 estimates the coefficients of the state-action value function without using the QE in a case where the optimization problem is not Included in the mathematical expression for estimating the coefficients of the state-action value function. Mathematical expressions that do not include the optimization problem are capable of referring to, for example, SARSA. Accordingly, the update unit 505 is capable of estimating the coefficients of the state-action value function, and improving the state-action value function.

The update unit 505 estimates the coefficients of the state-action value function by using the QE based on the acquired input value related to the state, the input value related to the action, and the gain. The update unit 505 estimates the coefficients of the state-action value function by using the QE in a case where the optimization problem is included in the mathematical expression for estimating the coefficients of the state-action value function.

Specifically, the update unit 505 specifies a possible range of the state-action value function by using the QE for the logical expression including the state-action value function based on the acquired input value related to the state and the input value related to the action. Next, the update unit 505 obtains the optimum value of the state-action value function by using the QE for the logical expression including the specified range. The update unit 505 estimates the coefficients of the state-action value function by using the obtained optimum value based on the acquired input value related to the state, the input value related to the action, and the gain. An operation example of the update unit 505 will be described later in the example, for example. Accordingly, the update unit 505 is capable of estimating the coefficients of the state-action value function, and improving the state-action value function.

The output unit 506 outputs the action determined by the action determination unit 503 to the control target 110. Accordingly, the output unit 506 is capable of controlling the control target 110. The output unit 506 may output the processing result of each processing unit. Examples of the output format include, for example, display on a display, printing output to a printer, transmission to an external device by a network I/F 203, and storing in a storage region, such as the memory 202 or the recording medium 205.

(Flow of Reinforcement Learning in Example)

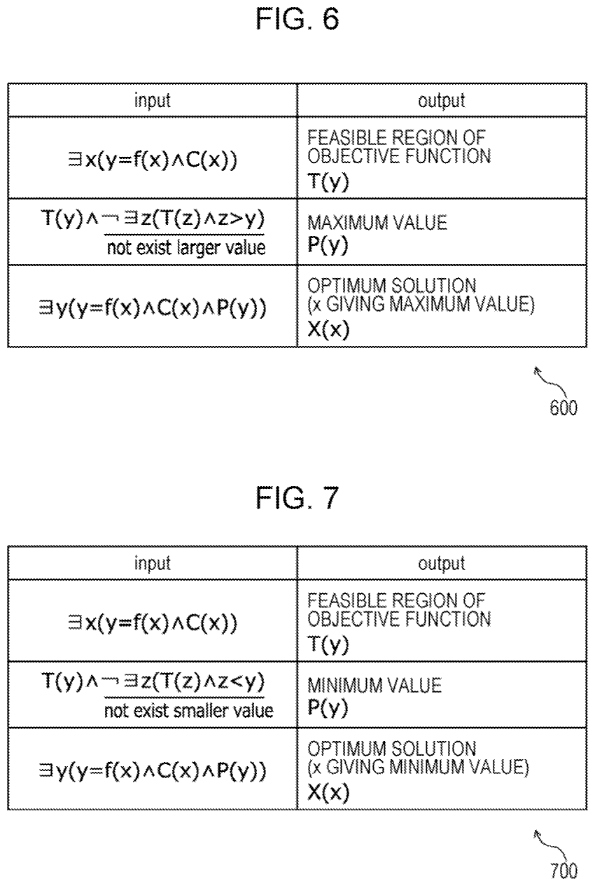

Next, a flow of the reinforcement learning in the example will be described using FIGS. 6 and 7.

FIGS. 6 and 7 are explanatory diagrams illustrating the flow of the reinforcement learning in the example. In the example of FIG. 6, a case where the reinforcement learning apparatus 100 controls the control target 110 so as to maximize the state-action value function will be described. In this case, as illustrated in a table 600, the reinforcement learning apparatus 100 controls the control target 110 by obtaining the optimum value or the optimum action of the state-action value function by using the QE so as to output the right logical expression when the left logical expression is input.

The QE is to convert a logical expression described by using a quantifier into an equivalent logical expression that does not use a quantifier. The quantifier is a universal quantifier (∀) and an existential quantifier (∃). The universal quantifier (∀) is a symbol that expresses that all real numbers are targets. The existential quantifier (∃) is a symbol that expresses that there are one or more target real numbers. Regarding the QE, it is possible to refer to, for example, Reference Literatures 5 to 7 in the following.

Reference Literature 5: Basu, Saugata. Richard Pollack, and Marie-Francoise Roy. “Algorithms in real algebraic geometry.” Vol. 10, Springer, Jun. 26, 2016.

Reference Literature 6: Caviness, Bob F., and Jeremy R. Johnson, eds. “Quantifier elimination and cylindrical algebraic decomposition.” Springer Wien New York, 1998.

Reference Literature 7: Hitoshi Yanami, “Multi-objective design based on symbolic computation and its application to hard disk slider design.” Journal of Math-for-Industry. Vol. 1(2009B-8).

In FIG. 6, the first row of the table 600 illustrates that a logical expression including a function y=f(x) and a constraint condition C(x) is convertible into a logical expression illustrating an feasible region T(y) of the function y=f(x), by the QE. The feasible region T(y) is a possible range of the function y=f(x). The second row of the table 600 illustrates that a logical expression including the condition that there is no z greater than y, including the feasible region T(y) is convertible into a logical expression illustrating the maximum value P(y) of the function y=f(x), by the QE.

The third row of the table 600 illustrates that a logical expression including the function y=f(x), the constraint condition C(x), and the maximum value P(y) of the function y=f(x) is convertible into a logical expression illustrating an optimum solution X(x) of the function y=f(x), by the QE. The optimum solution is a solution that makes it possible to make the function y=f(x) the maximum value P(y).

The reinforcement learning apparatus 100 applies the QE as illustrated in the table 600 to the state-action value function. For example, the reinforcement learning apparatus 100 replaces the function f(x) in the table 600 with the following expression (1) that indicates the state-action value function. Q (s, a) is a state-action value function. s is a state. a is an action. wᵢ is a coefficient learned by the reinforcement learning. wᵢ is stored by the coefficient array W. wᵢϕᵢ(s, a) is a term including a variable that represents a state and an action with a coefficient. ϕᵢ(s, a) is a term for expressing the state-action value function so as to become a polynomial with respect to a result a after substituting a value for s with a monomial of degree 2 or less of s and a.

Q(s,a)=Σwᵢϕᵢ(s,a) (1)

Accordingly, the reinforcement learning apparatus 100 is capable of obtaining a logical expression that is equivalent to the logical expression including the above-described expression (1) that indicates the state-action value function, does not include the quantifier, and does not include the action a, and is capable of obtaining the optimum action or the optimum value of the above-described expression (1) that indicates the state-action value function. Therefore, the reinforcement learning apparatus 100 is capable of realizing the reinforcement learning when the action a is a continuous quantity.

Since the reinforcement learning apparatus 100 is capable of obtaining the optimum value of the above-described expression (1) that indicates the state-action value function, in a case of using Q learning as the update rule, using the following expression (2), it is possible to update the coefficient wᵢ of the above-described expression (1) that indicates the state-action value function, and to improve the state-action value function. For example, the reinforcement learning apparatus 100 is capable of substituting the optimum value of the above-described expression (1) that indicates the state-action value function for the underlined portion of the following expression (2). t is a time point. sₜ is a state at time point t. aₜ is an action at time point t. rₜ is a gain for the action aₜ time point t.

$${w}_{i} ← {w}_{i} + a \frac{\partial Q ( {s}_{t} , {a}_{t} )}{\partial {w}_{i}} ( {r}_{t} + \underline{γ { max}_{a} Q ( {s}_{t + 1} , a )} - Q ( {s}_{t} , {a}_{t} ) ) \qquad ( 2 )$$

The reinforcement learning apparatus 100 is capable of using the constraint condition C(x). The reinforcement learning apparatus 100 is capable of realizing the reinforcement learning in consideration of the constraint conditions for action by using, for example, the following expression (3) and the following expression (4) as the constraint condition C(x). In the following expression (3) and the following expression (4), a₁ and a₂ are variables included in a plurality of variables a₁, a₂, . . . , aₙ that represent the action a at a certain time point.

0≤a₁≤1∧1≤a₂≤3 (3)

a₁=0∧a₂=0 (4)

Accordingly, in the reinforcement learning apparatus 100, it is possible to use the constraint condition in the reinforcement learning, and to control the control target 110 by accurately considering the properties of the control target 110. Therefore, in the reinforcement learning apparatus 100, it is possible to apply the reinforcement learning to various types of control targets 110, and to improve the convenience of the reinforcement learning. Specific examples of making it possible to use the constraint condition will be described later in the example. Next, the description continues with reference to FIG. 7.

In the example of FIG. 6, a case where the reinforcement learning apparatus 100 controls the control target 110 so as to maximize the state-action value function has been described. In contrast, in the example of FIG. 7, a case where the reinforcement learning apparatus 100 controls the control target 110 so as to minimize the state-action value function will be described. In this case, as illustrated in a table 700, the reinforcement learning apparatus 100 controls the control target 110 by obtaining the optimum value or the optimum action of the state-action value function by using the QE so as to output the right logical expression when the left logical expression is input.

Since the first row of the table 700 is the same as the first row of the table 600, the description thereof will be omitted. The second row of the table 700 illustrates that a logical expression including the condition that there is no z smaller than y, including the feasible region T(y) is convertible into a logical expression illustrating the minimum value P(y) of the function y=f(x), by the QE.

The third row of the table 700 illustrates that a logical expression including the function y=f(x), the constraint condition C(x), and the minimum value P(y) of the function y=f(x) is convertible into a logical expression illustrating an optimum solution X(x) of the function y=f(x), by the QE. The optimum solution is a solution that makes it possible to make the function y=f(x) the minimum value P(y).

The reinforcement learning apparatus 100 applies the QE as illustrated in the table 700 to the state-action value function. Since a specific example of applying the QE illustrated in the table 700 to the state-action value function is the same as the specific example of applying the QE as illustrated in the table 600 to the state-action value function, the description thereof will be omitted.

The reinforcement learning apparatus 100 may represent the state-action value function by a polynomial for both the variable that represents the state and the variable that represents the action. In this case, when the mathematical expression for obtaining the optimum value of the state-action value function or the optimum action in advance by the QE, the reinforcement learning apparatus 100 may not use the QE every time the optimum value of the state-action value function or the optimum action is obtained, and it is possible to reduce the amount of processing.

(Specific Example of Reinforcement Learning in Example)

Next, a specific example of the reinforcement learning in the example will be described. In the example, a specific example of the reinforcement learning in which the reinforcement learning apparatus 100 controls the control target 110 so as to maximize the state-action value function will be described.

In the example, the setting unit 501 sets ϕᵢ(s, a) that defines the state-action value function in the above-described expression (1). For example, the setting unit 501 sets, for example, ϕᵢ(s, a) based on the operation input of the user. Specifically, the setting unit 501 sets ϕᵢ(s, a) as a polynomial for a as illustrated in the following expression (5). d_{i,j} is defined by the following expression (6). It is possible to set an arbitrary function for ψⱼ.

$$\begin{matrix}{φ}_{i} ( s , a ) = {\sum }_{j} {ψ}_{j} ( s ) {a}_{1}^{{d}_{i , j}} … {a}_{m}^{{d}_{m , j}} & ( 5 ) \\ {d}_{i , j} ∈ {ℤ}_{\geq 0} & ( 6 )\end{matrix}$$

For example, there is a case where the setting unit 501 sets ϕᵢ(s, a) with a monomial of degree 2 or less of s and a. In this case, for example, “ϕ₁=1, ϕ₂=s₁, ϕ₃=s₂, . . . , ϕₙ₊₂=aᵢt, . . . ” are set.

For example, there is a case where the setting unit 501 sets ϕᵢ(s, a) so as to obtain a polynomial for a as a result of substituting a value to s. In this case, for example, “ϕ1=1, ϕ2=exp(s1), . . . , ϕn+2=a1*exp(s2), . . . ” is set. Accordingly, the setting unit 501 is capable of using the state-action value function, and treating the action as a continuous quantity using a polynomial.

The setting unit 501 sets the constraint condition C(s, a). For example, the setting unit 501 sets, for example, the constraint condition C(s, a) based on the operation input of the user. The constraint condition C(s, a) is defined in the form of a first-order predicate logical expression regarding s and a, for example. The constraint condition C(s, a) is defined as a polynomial for a. Accordingly, the setting unit 501 is capable of using the constraint condition in the reinforcement learning, and controlling the control target 110 by accurately considering the properties of the control target 110.

The setting unit 501 initializes the coefficient array W. For example, the setting unit 501 initializes the coefficient w which is an element of the coefficient array W with a random value in a range of −1 to 1. The setting unit 501 may initialize the coefficient wᵢ, which is an element of the coefficient array W, with a model related to the control target 110 based on the operation input of the user.

The setting unit 501 initializes a variable t that indicates a time point. For example, the setting unit 501 sets a variable t=0 that indicates a time point. The variable t is, for example, a variable that indicates a time point for each unit time. The variable t is, for example, a variable that is incremented every time the unit time elapses.

Thereafter, the state acquisition unit 502, the action determination unit 503, the gain acquisition unit 504, and the update unit 505 repeat processing as described below.

In the example, the state acquisition unit 502 observes the state sₜ of the control target 110 at time point t for each unit time and stores the observed state sₜ using the history table 400.

In the example, the action determination unit 503 reads the state sₜ of the control target 110 at time point t from the history table 400 for each unit time and determines the action for the control target 110. The action determination unit 503 determines an optimum action aₜ that makes it possible to maximize the state-action value function Q(sₜ, a) by using, for example, the QE.

First, specifically, the action determination unit 503 applies the QE to the logical expression on the right side of the following expression (7), and specifies a possible range T(F) of the value of the state-action value function Q(sₜ a) Illustrated on the left side of the following expression (7). The state-action value function Q(sₜ, a) becomes a polynomial for a because it is possible to substitute sₜ. The following expression (7) corresponds to the first row of the table 600.

T(F)=3a₁. . . 3aₘ(F=Q(sₜ,a)∧C(sₜ,a)) (7)

Next, the action determination unit 503 applies the QE to the logical expression on the right side of the following expression (8) including the range T(F), and specifies the maximum value T*(F*) of the state-action value function Q(sₜ, a) illustrated on the left side of the following expression (8). The superscript * is a symbol that Indicates the maximum value. The following expression (8) corresponds to the second row of the table 600.

T*(F*)≡∀F(T(F)→F*≥F∧T(F*)) (8)

The action determination unit 503 applies the QE to the logical expression on the right side of the following expression (9) including the maximum value T*(F*), and specifies the optimum action T*ₐ(a) that makes it possible to make the state-action value function Q(sₜ, a) illustrated on the left side of the following expression (9) as the maximum value T*(F*). The superscript * is a symbol that indicates the optimum action. The following expression (9) corresponds to the third row of the table 600.

T*ₐ(a)≡∃F*(F*=Q(sₜ,a)∧C(sₜ,a)∧T*(F*)) (9)

By giving the optimum action T*ₐ(a) or an exploratory action obtained by adding noise to the optimum action T*ₐ(a) to the control target 110 via the output unit 506, the action determination unit 503 controls the control target 110. The action determination unit 503 stores the action aₜ given to the control target 110 using the history table 400.

Accordingly, in the action determination unit 503, in the reinforcement learning, it is possible to treat the action as a continuous quantity, to finely adjust the action, and to efficiently control the control target 110. Since the action determination unit 503 is capable of obtaining the optimum value of the state-action value function without comprehensively calculating the value of the state-action value function using all of the continuous actions, it is possible to suppress an increase in time required for the reinforcement learning.

In the example, the gain acquisition unit 504 acquires a gain rₜ₋₁ that corresponds to the action aₜ from the control target 110 when the variablet=t+1 that indicates the time point is established after the unit time when the action aₜ is given to the control target 110. The gain rₜ₋₁, is a scalar quantity. The gain acquisition unit 504 stores the gain rₜ₋₁ using the history table 400.

In the example, the update unit 505 updates the coefficient arrayW=w₁, . . . , wₙ at a predetermined timing. The predetermined timing is, for example, a timing every time the action determination unit 503 obtains the action aₜ N times and gives the action aₜ to the control target 110.

For example, in a case where the records that correspond to the time points t0, . . . , tk are stored in the history table 400 using the Q learning as an update rule, the update unit 505 performs processing with respect to the time points t0, . . . , tk−1 using the update rule illustrated in the following expression (10). It is possible to acquire sₜ, aₜ, sₜ₊₁, and rₜ from the history table 400.

$${w}_{i} ← {w}_{i} + a \frac{\partial Q ( {s}_{t} , {a}_{t} )}{\partial {w}_{i}} ( {r}_{t} + γ { max}_{a} Q ( {s}_{t + 1} , a ) - Q ( {s}_{t} , {a}_{t} ) ) \qquad ( 10 )$$

The update unit 505 calculates a max portion of the above-described expression (10) by using the QE. A constraint condition may be defined for the max portion. First, specifically, the update unit 505 applies the QE to the logical expression on the right side of the following expression (11), and specifies the possible range T(F) of the value of the state-action value function Q(sₜ₊₁, a) illustrated on the left side of the following expression (11). The state-action value function Q(sₜ₊₁, a) is expressed by a polynomial for a. The following expression (11) corresponds to the first row of the table 600.

T(F)≡∃a₁. . . ∃aₘ(F=Q(sₜ,a)∧C(sₜ₊₁,a)) (11)

Next, the update unit 505 applies the QE to the logical expression on the right side of the following expression (12) including the range T(F), and specifies the maximum value T*(F*) of the state-action value function Q(sₜ₊₁, a) illustrated on the left side of the following expression (12). The superscript * is a symbol that indicates the maximum value. The following expression (12) corresponds to the second row of the table 600.

T*(F*)≡∀F(T(F)→F*≥F∧T(F*)) (12)

The update unit 505 updates the coefficient array W=w₁, . . . , wₙ based on the above-described expression (10) by using the maximum value T*(F*) in the max portion of the above-described expression (10).

Accordingly, the update unit 505 is capable of updating the coefficient array W=w₁, . . . , wₙ, improving the state-action value function so as to accurately illustrate the cumulative gain of the control target 110, and efficiently controlling the control target 110. The update unit 505 deletes the record in the history table 400, leaving the last record. For example, when the SARSA is referred to as the update rule, the update unit 505 may not calculate the max portion.

(Specific Example of Control Target 110)

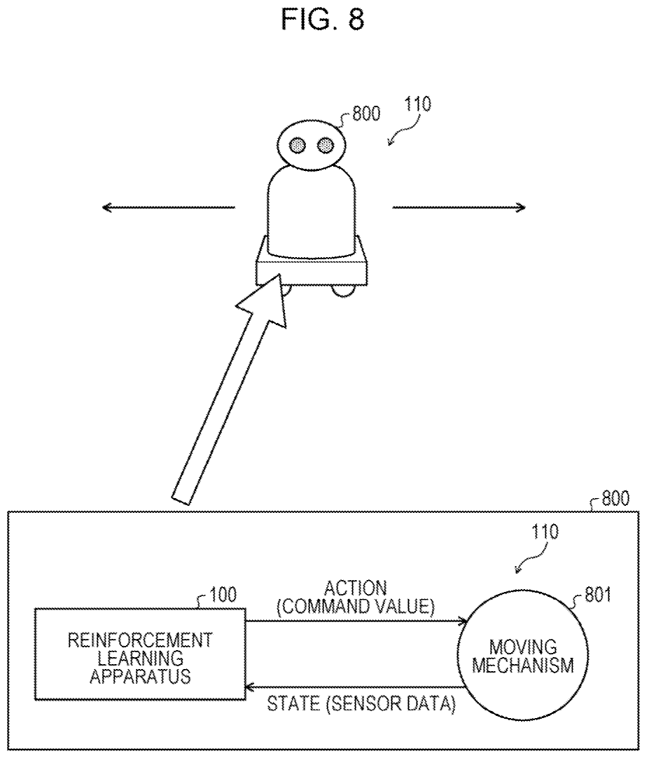

Next, a specific example of the control target 110 will be described with reference to FIGS. 8 to 10.

FIGS. 8 to 10 are explanatory diagrams illustrating specific examples of the control target 110. In the example of FIG. 8, the control target 110 is an autonomous mobile robot 800, specifically, a moving mechanism 801 of the autonomous mobile robot 800. The action is a command value for the moving mechanism 801, such as a moving direction or a moving distance. It is possible to treat the moving direction or the moving distance as a continuous quantity.

The state is sensor data from a sensor device provided in the autonomous mobile robot 800, such as the position of the autonomous mobile robot 800. The gain is, for example, a value obtained by multiplying a short-term error between the target position of the autonomous mobile robot 800 and the current position of the autonomous mobile robot 800 by a negative value. The state-action value function is, for example, a function that represents a value obtained by multiplying a long-term error between the target position of the autonomous mobile robot 800 and the current position of the autonomous mobile robot 800 by a negative value, as a cumulative gain.

The reinforcement learning apparatus 100 is capable of updating the coefficients of the state-action value function so as to efficiently minimize the long-term error, determining the command value to be the next action, and controlling the moving mechanism 801 that is the control target 110. At this time, the reinforcement learning apparatus 100 is capable of setting a command value for the next action in fine units, and efficiently controlling the moving mechanism 801 that is the control target 110. For example, the reinforcement learning apparatus 100 is capable of specifying the moving direction in any direction of 360 degrees, and efficiently controlling the moving mechanism 801 that is the control target 110. Controlling the moving mechanism 801 may be effectuated through, for example, the transmission of a control signal to the control target 110.

Therefore, the reinforcement learning apparatus 100 is capable of reducing the time required until the error is minimized, and the autonomous mobile robot 800 is capable of accurately and quickly reaching the final target position.

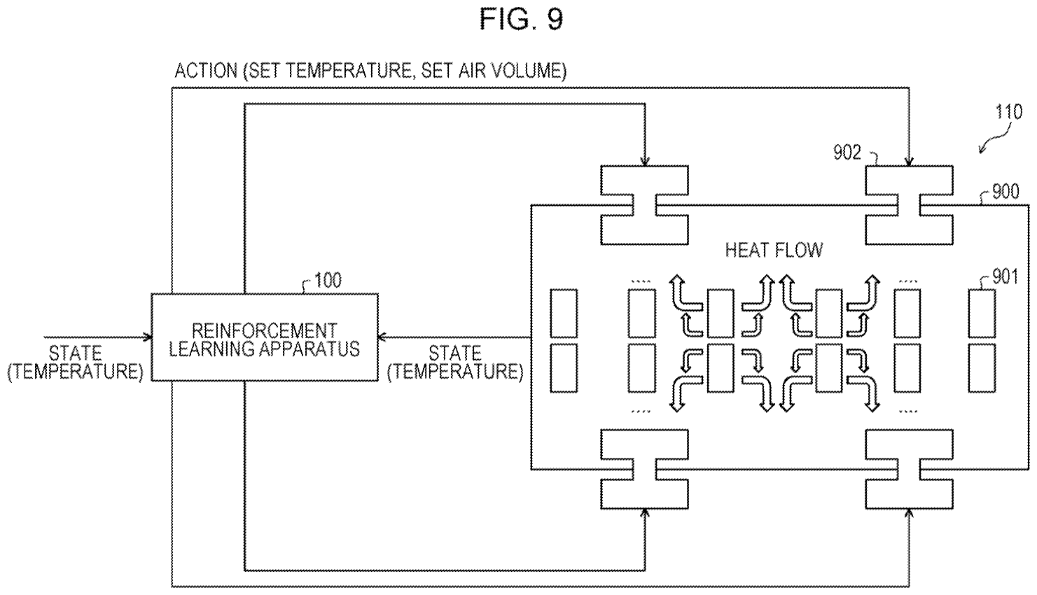

In the example of FIG. 9, the control target 110 is computer room air conditioning (CRAC) unit for a server room 900 including a server 901 that is a heat source. The action is a set temperature or a set air volume for the cooler 902. The state is sensor data from a sensor device provided in the server room 900, such as the temperature. The state may be data related to the control target 110 obtained from a target other than the control target 110, and may be, for example, temperature or weather. The gain is, for example, a value obtained by multiplying the power consumption for 5 minutes in the server room 900 by a negative value. The state-action value function is, for example, a function that represents a value obtained by multiplying the accumulated power consumption for 24 hours in the server room 900 by a negative value as a cumulative gain.

The reinforcement learning apparatus 100 is capable of updating the state-action value function so as to efficiently minimize the accumulated power consumption for 24 hours, and efficiently determining the next optimum action. At this time, the reinforcement learning apparatus 100 is capable of setting the set temperature and the set air volume, which are the next actions, in fine units, and efficiently controlling the CRAC unit 902 that is the control target 110. Setting the set temperature and the set air volume may be effectuated through, for example, the transmission of a control signal to the CRAC unit.

Therefore, the reinforcement learning apparatus 100 is capable of reducing the time required until the accumulated power consumption of the control target 110 is minimized, and reducing the operating cost of the CRAC unit 902. Even in a case where a change in the use status of the server 901 or a change in temperature occurs, the reinforcement learning apparatus 100 is capable of efficiently minimizing the accumulated power consumption in a relatively short period of time from the change.

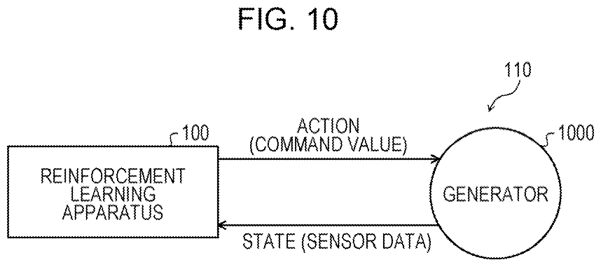

In the example of FIG. 10, the control target 110 is a generator 1000. The action is a command value for the generator 1000. The state is sensor data from a sensor device provided in the generator 1000, and is, for example, a power generation amount of the generator 1000, a rotation amount of a turbine of the generator 1000, or the like. The gain is, for example, a power generation amount for 5 minutes of the generator 1000. The state-action value function is, for example, a function that represents an accumulated power generation amount for 24 hours of the generator 1000 as a cumulative gain.

The reinforcement learning apparatus 100 is capable of updating the coefficients of the state-action value function so as to efficiently maximize the accumulated power generation amount for 24 hours, determining the command value to be the next action, and controlling the generator 1000 that is the control target 110. At this time, the reinforcement learning apparatus 100 is capable of setting a command value for the next action in fine units, and efficiently controlling the generator 1000 that is the control target 110.

Therefore, the reinforcement learning apparatus 100 is capable of reducing the time required until the accumulated power generation amount of the control target 110 is maximized, and increasing the profit of the generator 1000. Even in a case where a change in the status of the generator 1000 occurs, the reinforcement learning apparatus 100 is capable of efficiently maximizing the accumulated power generation amount in a relatively short period of time from the change. The control target 110 may be, for example, a chemical plant.

(Example of Reinforcement Learning Processing Procedure)

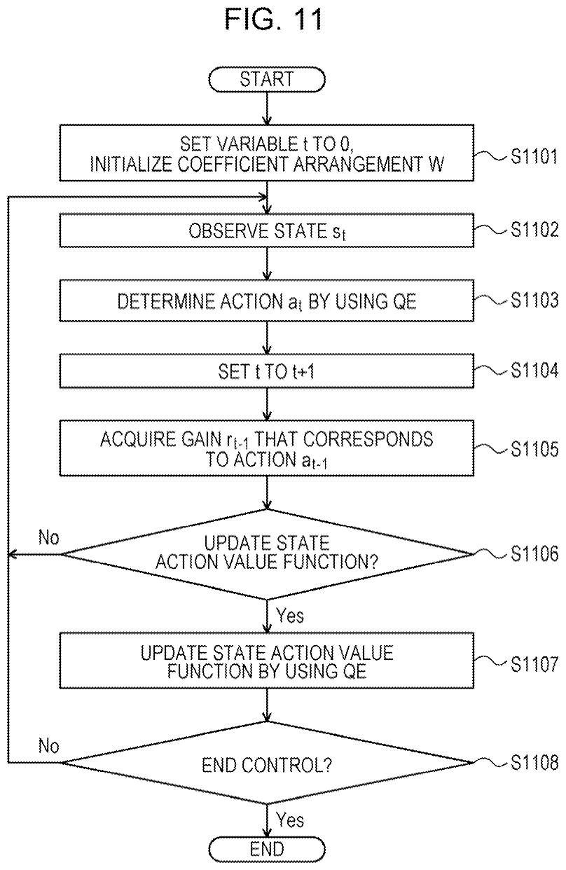

Next, an example of the reinforcement learning processing procedure will be described with reference to FIG. 11.

FIG. 11 is a flowchart illustrating an example of a reinforcement learning processing procedure. In FIG. 11, the reinforcement learning apparatus 100 sets the variable t to 0 and initializes the coefficient array W (step S1101).

Next, the reinforcement learning apparatus 100 observes the state sₜ (step S1102). The reinforcement learning apparatus 100 determines the action at that optimizes the state-action value function by using the QE (step S1103). Next, the reinforcement learning apparatus 100 sets t to t+1 (step S1104). The reinforcement learning apparatus 100 acquires a gain rₜ₋₁ that corresponds to the action aₜ₋₁ (step S1105).

Next, the reinforcement learning apparatus 100 determines whether or not to update the state-action value function (step S1106). The update is performed, for example, every time a series of processing in steps S1102 to S1105 is executed N times. In a case where the state-action value function is not updated (step S1106: No), the reinforcement learning apparatus 100 returns to the processing of step S1102. Meanwhile, in a case where the state-action value function is updated (step S1106: Yes), the reinforcement learning apparatus 100 updates the state-action value function by using the QE (step S1107).

Next, the reinforcement learning apparatus 100 determines whether or not to end the control of the control target 110 (step S1108). In a case where the control does not end (step S1108: No), the reinforcement learning apparatus 100 returns to the processing of step S1102. Meanwhile, in a case where the control ends (step S1108: Yes), the reinforcement learning apparatus 100 ends the reinforcement learning processing. Accordingly, the reinforcement learning apparatus 100 is capable of treating the action as a continuous quantity in the reinforcement learning.

In the example of FIG. 11, a case where the reinforcement learning apparatus 100 executes the reinforcement learning processing in a batch processing format has been described, but the present embodiment is not limited thereto. For example, there may be a case where the reinforcement learning apparatus 100 executes the reinforcement learning processing in a sequential processing format.

As described above, according to the reinforcement learning apparatus 100, it is possible to acquire the input value related to the state and the action and the gain that corresponds to the input value. According to the reinforcement learning apparatus 100, it is possible to estimate the coefficients of the state-action value function based on the acquired input value and gain. According to the reinforcement learning apparatus 100, it is possible to obtain the optimum action or the optimum value of the state-action value function with the estimated coefficients by using the QE. Accordingly, in the reinforcement learning apparatus 100, in the reinforcement learning, it is possible to treat the action as a continuous quantity, and it is possible to finely adjust the action, and to efficiently control the control target 110. The reinforcement learning apparatus 100 is capable of suppressing an increase in the time required for the reinforcement learning.

According to the reinforcement learning apparatus 100, it is possible to specify the range of the state-action value function by using the QE for the logical expression including the state-action value function based on the acquired input value. According to the reinforcement learning apparatus 100, it is possible to obtain the optimum value of the state-action value function by using the QE for the logical expression including the specified range. According to the reinforcement learning apparatus 100, it is possible to obtain the optimum action of the state-action value function by using the QE for the logical expression including the obtained optimum value. Accordingly, the reinforcement learning apparatus 100 is capable of obtaining the optimum value of the state-action value function by deleting the variables related to the action and obtaining the optimum action of the state-action value function.

According to the reinforcement learning apparatus 100, it is possible to estimate the coefficients of the state-action value function by using the QE based on the acquired input value and gain. Accordingly, the reinforcement learning apparatus 100 is capable of improving the state-action value function by estimating the coefficients of the state-action value function even in a case of performing the optimization problem when obtaining the coefficients of the state-action value function.

According to the reinforcement learning apparatus 100, it is possible to specify the range of the state-action value function by using the QE for the logical expression including the state-action value function based on the acquired input value. According to the reinforcement learning apparatus 100, it is possible to obtain the optimum value of the state-action value function by using the QE for the logical expression including the specified range. According to the reinforcement learning apparatus 100, it is possible to estimate the coefficients of the state-action value function by using the obtained optimum value based on the acquired input value and gain. Accordingly, the reinforcement learning apparatus 100 is capable of obtaining the optimum value of the state-action value function by deleting the variables related to the action and estimating the coefficients of the state-action value function.

According to the reinforcement learning apparatus 100, it is possible to obtain the optimum action or the optimum value of the state-action value function with the estimated coefficients, to which the constraint condition is applied, by using the QE. Accordingly, in the reinforcement learning apparatus 100, it is possible to use the constraint condition in the reinforcement learning, and to control the control target 110 by accurately considering the properties of the control target 110.

According to the reinforcement learning apparatus 100, it is possible to obtain the optimum action or the optimum value of the state-action value function by using a predetermined coefficient, by using the QE. Accordingly, the reinforcement learning apparatus 100 is capable of obtaining the optimum action or the optimum value even at a time point when the coefficients of the state-action value function has not been estimated yet.

It is possible to realize the reinforcement learning method described according to the embodiment by causing a computer, such as a personal computer or a workstation, to execute a prepared program. The reinforcement learning program described according to the embodiment is recorded on a computer-readable recording medium, such as a hard disk, a flexible disk, a compact disc read-only memory (CD-ROM), a magneto-optical (MO) disc, or a digital versatile disc (DVD), and is executed as a result of being read from the recording medium by a computer. The reinforcement learning program described according to the present embodiment may be distributed through a network, such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a reinforcement learning program for causing a computer to execute a process comprising:
acquiring an input value related to a state and an action of a control target and a gain of the control target that corresponds to the input value;
estimating coefficients of state-action value function that becomes a polynomial for a variable that represents the action of the control target, or becomes a polynomial for a variable that represents the action of the control target when a value is substituted for a variable that represents the state of the control target, based on the acquired input value and the gain;
obtaining an optimum action or an optimum value of the state-action value function with the estimated coefficients by using a quantifier elimination; and
transmitting a control signal based on the optimum action or the optimum value to the control target.

2. The non-transitory computer-readable recording medium according to claim 1,
wherein the obtaining is to specify a range of the state-action value function by using a quantifier elimination for a logical expression including the state-action value function based on the acquired input value, obtain an optimum value of the state-action value function by using a quantifier elimination for a logical expression including the specified range, and obtain an optimum action of the state-action value function by using a quantifier elimination for a logical expression including the obtained optimum value.

3. The non-transitory computer-readable recording medium according to claim 1,
wherein the estimating is to estimate the coefficients of the state-action value function by using a quantifier elimination based on the acquired input value and the gain.

4. The non-transitory computer-readable recording medium according to claim 3,
wherein the estimating is to
specify a range of the state-action value function by using a quantifier elimination for a logical expression including the state-action value function based on the acquired input value, and obtain an optimum value of the state-action value function by using a quantifier elimination for a logical expression including the specified range, and
estimate coefficients of the state-action value function by using the obtained optimum value based on the acquired input value and the gain.

5. The non-transitory computer-readable recording medium according to claim 1,
wherein the obtaining is to obtain the optimum action or the optimum value of the state-action value function with the estimated coefficients, to which a constraint condition is applied, by using a quantifier elimination.

6. The non-transitory computer-readable recording medium according to claim 1,
wherein the obtaining is to obtain the optimum action or the optimum value of the state-action value function with a predetermined coefficient, by using a quantifier elimination.

7. The non-transitory computer-readable recording medium according to claim 1, wherein the control target is a moving mechanism of an autonomous robot.

8. The non-transitory computer-readable recording medium according to claim 1, wherein the control target is a computer room air conditioning (CRAC) unit.

9. A reinforcement learning method to be performed by a computer, the method comprising:
acquiring an input value related to a state and an action of a control target and a gain of the control target that corresponds to the input value;
estimating coefficients of state-action value function that becomes a polynomial for a variable that represents the action of the control target, or becomes a polynomial for a variable that represents the action of the control target when a value is substituted for a variable that represents the state of the control target, based on the acquired input value and the gain;
obtaining an optimum action or an optimum value of the state-action value function with the estimated coefficients by using a quantifier elimination; and
transmitting a control signal based on the optimum action or the optimum value to the control target.

10. The reinforcement learning method according to claim 9, wherein the control target is a moving mechanism of an autonomous robot.

11. The reinforcement learning method according to claim 9, wherein the control target is a computer room air conditioning (CRAC) unit.

12. A reinforcement learning apparatus comprising:
a memory, and
a processor coupled to the memory and configured to:
acquire an input value related to a state and an action of a control target and a gain of the control target that corresponds to the input value;
estimate coefficients of state-action value function that becomes a polynomial for a variable that represents the action of the control target, or becomes a polynomial for a variable that represents the action of the control target when a value is substituted for a variable that represents the state of the control target, based on the acquired input value and the gain;
obtain an optimum action or an optimum value of the state-action value function with the estimated coefficients by using a quantifier elimination; and
transmit a control signal based on the optimum action or the optimum value to the control target.

13. The reinforcement learning apparatus according to claim 12, wherein the control target is a moving mechanism of an autonomous robot.

14. The reinforcement learning apparatus according to claim 12, wherein the control target is a computer room air conditioning (CRAC) unit.
